(19) United States
(12) Patent Application Publication
(10) Pub. No.: US 2025/0134109 A1
(43) Pub. Date: May 1, 2025

(54) Antimicrobial, Antiviral and Antifungal Articles and Methods of Producing Such Articles

(71) Applicant: Cupron, Inc., Richmond, VA (US)

(72) Inventors: Vikram Kanmukhla, Glen Allen, VA (US); Rachel Salvatori, Richmond, VA (US)

(73) Assignee: Cupron, Inc., Richmond, VA (US)

(21) Appl. No.: 18/681,804

(22) PCT Filed: Aug. 7, 2022
(86) PCT No.: PCT/US2022/039661

§ 371 Date: Feb. 6, 2024

Related U.S. Application Data
(60) Provisional application No. 63/230,528, filed on Aug. 6, 2021.

(51) Int. Cl. A01N 59/20; A01N 25/10; A01N 25/34; A01P 1/00; A01P 3/00

(52) U.S. Cl. CPC A01N 59/20; A01N 25/10; A01N 25/34; A01P 1/00; A01P 3/00

(57) ABSTRACT

Polymeric articles having improved antimicrobial, antiviral, and antifungal properties and/or other improved properties obtainable from embedding particles in polymers are described. The articles may have a plurality of first particles that provide a desired first desired property to the article and a plurality of second particles that provide a desired second desired property to the article. In some cases, the particles may comprise or consist essentially of at least one of water soluble and water insoluble copper compounds that release at least one of Cu+ ions and Cu++ ions upon contact with a fluid. The polymeric articles may have different properties and efficacy based upon the chemical composition, the size, shape, and location of the combination of particles in the article.

### FIELD OF THE INVENTION

Polymeric articles having improved antimicrobial, antiviral, and antifungal properties and/or other improved properties obtainable from embedding particles in polymers are described. Embodiments of the articles comprise a plurality of first particles that provide a desired first desired property to the article and a plurality of second particles that provide a desired second desired property to the article. In embodiments of the article, the particles may comprise or consist of at least one of water soluble and water insoluble copper compounds that release at least one of Cu+ ions and Cu++ ions upon contact with a fluid. Embodiments of the polymeric articles may have different properties and efficacy based upon the chemical composition, the size, shape, and location of the combination of particles in the article.

In some embodiments, the articles may comprise first particles in a first particle size range and second particles in a second particle size range. The different size particle sizes may have different antimicrobial, antiviral, and antifungal properties, for example, so the particle size ranges may be chosen to tailor the article or portions of the article for specific applications. In additional embodiments, the plurality of first particles and the plurality of second particles may comprise or consist of particles of different chemical composition such as different copper species, different metal species, and/or may be present in different concentrations or particle size ranges.

The articles may be an extruded article, a fiber, a yarn, a fabric, a sheet or film, a nonwoven, a solid surface including countertops or other polymeric sheets or panels, and a molded article such as a molded polymeric article, for example.

In other embodiments, the articles have a first antimicrobial copper particles and a second antimicrobial copper particles, wherein the antimicrobial copper particles have at least one of different copper ion release rates, different contact killing properties, different optical qualities, wound healing properties, root control properties, different particles size distributions, different average particle sizes thereby tailoring the articles for applications for use in antimicrobial articles including fibers, hard surfaces, articles that prevent root growth in contact with the article or in an area adjacent to the article, for pH control such as in incontinence devices, odor control, fire resistance, films, and/or wound dressings that are tailored for the combination of properties desired in the application, for example.

### BACKGROUND

It has been shown that polymeric materials comprising a small concentration of particles of water insoluble copper compounds that release at least one of Cu+ ions and Cu++ ions upon contact with a fluid are that embedded and/or protruding from the surface of the polymeric materials exhibit antimicrobial, antiviral and/or antifungal properties. Thus, such polymeric materials may be converted into products having antimicrobial, antiviral and/or antifungal properties including, but not limited to, fibers, yarns, films and solid surfaces through extrusion, spray, or molding processes, for example.

In certain embodiments, the antimicrobial particles may be added to a melted polymer to form a polymeric slurry. In prior art processes, the antimicrobial, antifungal, and/or antiviral component may be added directly to the polymer or added as a component of an antimicrobial and/or antiviral masterbatch. These particles have been of a single type of particle having the same physical and chemical properties, for example, a single particle size distribution.

There is a need for a process for producing antimicrobial, antifungal, and/or antiviral products that combine the properties of particles having different chemical or physical properties that deliver their the antimicrobial, antifungal, and/or antiviral effects differently.

### SUMMARY

An antimicrobial, antiviral, and antifungal polymeric materials are used in many applications where a microbes may be a problem. Embodiments of an antimicrobial, antiviral, and antifungal material may comprise a polymer and a combination of antimicrobial particles having different physical or chemical properties that provide enhanced efficacy or longer term efficacy in the article.

For example, the combination of antimicrobial, antiviral, or antifungal particles may comprise a plurality of first antimicrobial, antiviral, or antifungal particles within a first particle size range and a plurality of second antimicrobial, antiviral, or antifungal particles within a second particle size range. The first antimicrobial, antiviral, or antifungal particles may consist essentially of copper compounds that release at least one of Cu+ ions and Cu++ ions upon contact with a fluid embedded in the fiber, wherein the first particle size range is different than the second particle size range. The first particle size range may be considered different than the second particle size range if the average particle size of the first particle size range has a first average particle size, the second particle size range has a second average particle size and the first average particle size is different than the second average particle size such that the combination of the first particles and the second particles produces a mixture with a bimodal particle size distribution with peaks at each average particle size.

In other embodiments, the first particle size range and the second particle size range do not overlap. Particle size ranges are considered to not overlap when the particle size ranges of middle ninety percent of the particles (ignoring the particles with sizes in the lowest ten percent and the highest ten percent of the particle sample.) do not overlap.

The combination of combination of antimicrobial, antiviral, or antifungal particles may have different chemical compositions. For example, the first particles consist essentially of copper oxide particles and the second particles consist essentially of copper iodide particles.

In one specific embodiment, an incontinence device may comprise an absorbent layer, wherein the absorbent layer comprises a superabsorbent polymer. The superabsorbent layer may comprise a plurality of the first antimicrobial, antiviral, or antifungal particles are within a first particle size range and a plurality of second antimicrobial, antiviral, or antifungal particles within a second particle size range. The smaller particle size range may for immediate efficacy and the larger particles may comprise a more sustained efficacy, for example.

The incontinence device may also comprise a nonwoven top sheet. The top sheet comprises a polymeric material and a plurality of third particles, wherein the third particles comprise water insoluble copper compounds that release at least one of Cu+ ions and Cu++ ions upon contact with a fluid embedded in the polymeric material and the plurality of third particles having a third average particle diameter, wherein the average diameter of the particle is in the range of 5% and 10% of the average diameter of fibers of the polymeric material.

Embodiments of a method of producing an antimicrobial, antiviral, or antifungal article may comprise mixing a polymeric material, a first polymeric masterbatch comprising first particles comprising water insoluble copper compounds that release at least one of Cu+ ions and Cu++ ions upon contact with a fluid in a first particle size range, and a second polymeric masterbatch comprising second particles comprising water insoluble copper compounds that release at least one of Cu+ ions and Cu++ ions upon contact with a fluid in a second particle size range, wherein the first particle size range is different than the second particle size range.

In the method or in any of the articles, the particles in the first masterbatch may have a first rate of copper ion release and the particles of the second masterbatch have a second rate of copper ion release and the first rate of copper ion release is different than the second rate of copper ion release.

### DESCRIPTION OF THE DRAWINGS

FIG. 1 is a graph of the different copper ion release rates for different copper compounds versus the number of wash cycles; and

FIG. 2 is a graph of the copper ion release after exposure to water.

### DESCRIPTION OF THE INVENTION

Embodiments of articles comprising a plurality of copper compounds and having antimicrobial, antiviral, and antifungal properties are described herein to exemplify the invention. Such articles comprise an antimicrobial, antiviral and antifungal material or particle that kills, reduces, and/or controls the growth of at least one of microbes, bacteria, molds, and fungi. Polymeric materials comprising a relatively small concentration of particles of water insoluble copper compounds and/or water-soluble copper compounds that release at least one of Cu+ ions and Cu++ ions upon contact with a fluid (hereinafter “antimicrobial copper compounds”) are embedded and/or protruding from the surface of the polymeric materials exhibit antimicrobial, antiviral and/or antifungal properties in addition to other beneficial properties. Thus, such polymeric materials may be converted into articles, antimicrobial polymeric masterbatches, or other products having such properties including, but not limited to, fibers, yarns, films, molded products, nonwoven materials, and solid surfaces through continuous pour processes, extrusion, spray, or molding processes, for example.

In certain embodiments, the antimicrobial copper compounds may be added to a melted polymer to form polymeric slurry. Alternatively, the copper compounds may be added to monomers in a polymeric reaction slurry prior to or during a polymerization process and incorporated into the resultant polymer. The polymers may be any desired polymer including, but not limited to, a polyester, polyolefins, polyethylene, high density polyethylene, low density polyethylene, polystyrene, polyacrylates, polymethacrylates, polyethylene terephthalate (PET), polybutylene terephthalate (PBT), polytrimethylene terephthalate, polylactic acid (PLA), polyglycolide (PGA), polylactic-co-glycolic acid (PLGA), polyamides or nylon including, but not limited to, nylon-6 (polycaprolactum) and Nylon 66, polyurethanes, similar thermoplastic polymers or copolymers, super absorbent polymers, and combinations thereof. Polyesters are polymers formed from a dicarboxylic acid and a diol. The melted polymer slurry may be extruded to produce fibers, yarns or sheets which possess antimicrobial, antifungal and/or antiviral properties, formed into films, or molded in a batch or continuously.

Embodiments of a method of producing the antimicrobial, antiviral, and antifungal articles may comprise adding first antimicrobial copper particles and second antimicrobial particles, added as the first antimicrobial copper particles and the second antimicrobial copper particles may be a component of an antimicrobial copper particle masterbatch, or a combination thereof. The first antimicrobial copper particles and the second antimicrobial copper particles may be added directly to the polymer or with the raw materials of a polymerization process to produce the polymer to be formed into the article. United States Patent Application Publication No. US 2008/0193496 describes a method of producing an antimicrobial and antiviral masterbatch and processes for producing antimicrobial and antiviral masterbatch, and its disclosure is hereby incorporated by reference in its entirety.

Embodiments of a method of producing an antimicrobial, antiviral, and antifungal article include selecting two or more masterbatches from a plurality of masterbatches, wherein the masterbatches comprise antimicrobial copper particles having different particle size ranges, different copper compositions, and/or blends of copper compositions. In such a method, the articles may be tailored to have combinations of properties based upon the combination of the different antimicrobial copper particles. The masterbatches may include additional components that aid processing of the article.

Embodiments of a method of producing an antimicrobial, antiviral, and antifungal article include selecting two or more copper particles from a plurality of copper particles, wherein the copper particles comprise different particle size ranges, different copper compositions, and/or blends of copper compositions. In such a method, the articles may be tailored to have combinations of properties based upon the combination of the different antimicrobial copper particles.

Embodiments of the article comprise two distinct particles or powders having at least one different physical or chemical property. The properties of the antimicrobial copper particles include, but are not limited to, antimicrobial, antiviral and antifungal properties, ion release rates such as, but not limited to, copper ion release rate, particle size, copper structural state including amorphous or crystalline, contact killing properties, optical qualities, chemical composition, of combinations thereof, thereby tailoring the properties of the articles for various applications.

In one embodiment, an antimicrobial, antiviral and antifungal article or fiber comprises a polymeric material, a plurality of first particles comprising first antimicrobial copper compounds and a plurality of second particles comprising second antimicrobial copper compounds. In such an embodiment, the plurality of first particles may have a first particle size range and the plurality of second particle may have a second particle size range.

The concentration of the total antimicrobial copper compound may be any concentration that is effective to produce the desired results in the article. In certain embodiments of a final product, the concentration of the total antimicrobial copper compounds may be from 0.1 wt. % to 20 wt %, for example. In other embodiments such as, but not limited to, films and fibers the concentration of total antimicrobial copper compounds may be from 0.1 wt. % to 6 wt. %, for example. For embodiments of a polymeric masterbatch that may be blended into the production of other polymeric articles, the concentration of total antimicrobial copper compounds in the masterbatch may be from 10 wt % to 50 wt %.

It was surprisingly discovered that the different size particles have different ion release rates. In many embodiments, it is possible to provide ion release rates that are tailored to the specific application. For example, embodiments include articles that comprise first particles having a first ion release rate and second particles having a second ion release rate. The ion release rates for various copper compounds are shown in Table 1. The ion release rates of the compounds listed in Table 1

TABLE 1
Copper ion release rate from various copper compounds

| | Copper ion release (ppm) from 1.0μ particles | | | | | |
|---|---|---|---|---|---|---|
| Exposure cycle | CuSO₄ | CuCl | Cul | CuSCN | Cu₂O | Cu₂S |
| 0 | 100.0 | 10.0 | 6.0 | 4.0 | 3.5 | 0.5 |
| 5 | 0.0 | 1.3 | 3.0 | 2.7 | 3.0 | 0.5 |
| 10 | 0.0 | 0.2 | 1.5 | 1.8 | 2.7 | 0.5 |
| 15 | 0.0 | 0.0 | 0.7 | 1.3 | 2.3 | 0.5 |
| 20 | 0.0 | 0.0 | 0.4 | 0.9 | 2.1 | 0.5 |
| 25 | 0.0 | 0.0 | 0.2 | 0.6 | 1.9 | 0.5 |
| 30 | 0.0 | 0.0 | 0.1 | 0.4 | 1.7 | 0.5 |
| 35 | 0.0 | 0.0 | 0.0 | 0.3 | 1.5 | 0.5 |
| 40 | 0.0 | 0.0 | 0.0 | 0.2 | 1.3 | 0.5 |
| 45 | 0.0 | 0.0 | 0.0 | 0.1 | 1.2 | 0.5 |
| 50 | 0.0 | 0.0 | 0.0 | 0.0 | 1.1 | 0.5 |

are for particles having a one (1) micron diameter. The ion release rates listed may be considered to be an average ion release rate of a plurality of particles or powder having an average particle size of 1 micron also.

It was also surprisingly discovered that the different size particles have different microbe kill rates. In many embodiments, it is possible to provide kill rates that are tailored to the specific application. For example, embodiments include articles that comprise first particles having a first kill rate after incorporated into the specific article and second particles having a second kill rate after incorporated into the same specific article. The kill rates listed may be considered to be an average kill rate of a plurality of particles or powder. As shown in Table 1, copper sulfate is a soluble copper compound that quickly releases its copper ions into a fluid in less than five exposures. Such rapid release may be beneficial for short term applications or applications that may benefit from an initial dosing of copper ions, for example, where at least a portion of the copper ions are needed and used quickly. One such application may be with a top sheet or absorbent core of an incontinence device. The copper ions are immediately available for reducing odors and killing bacteria. Another example may be a wound dressing that quickly releases copper ions for wound healing and has additional compounds with a slower ion release to maintain contact killing of microbes and maintenance ions to the wound and surrounding skin.

For example, cuprous oxide particles have a slower ion release rate compared to copper sulfate or copper iodide. Initially, ion releases from cuprous oxide are higher but the particles continue to remain active and release ions over multiple exposures or wash cycles. In the example of an incontinence device, the durable ion release and particles of the copper oxides remaining within the fibers or other articles longer to provide continued antimicrobial, anti-odor protection to the wearer. Therefore, an incontinence device may comprise a nonwoven top sheet having either copper sulfate or cuprous oxide or a combination thereor to provide immediate release of ions into a first evacuation.

The cuprous oxide particles remain in the nonwoven top sheet while a significant portion of the copper sulfate ions are released into the urine and into any moisture remaining on the skin. The remaining active cuprous oxide particles are available for further evacuations and for contact killing of bacteria on the skin or on solids contacted by the nonwoven top sheet.

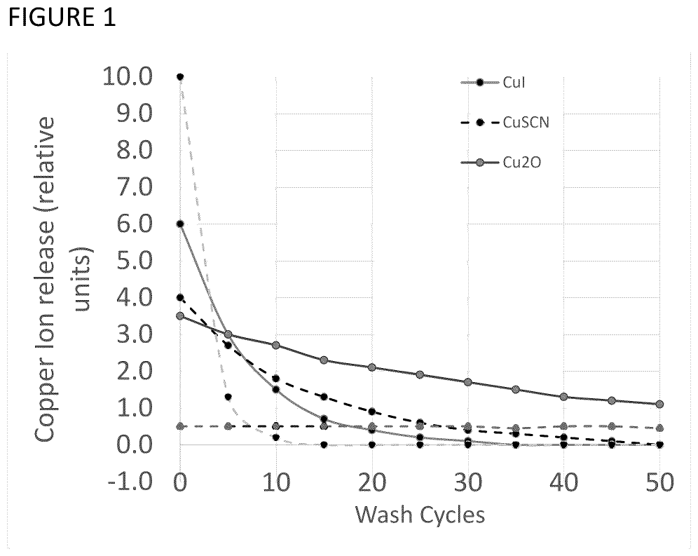

In another embodiment, the absorbent core of the incontinence device may also comprise copper sulfate for immediate ion release after an exposure to liquid to prevent microbe growth and reduce odors. FIG. 1 is a graphical representation of the data in Table 1.

Table 2 provides data for articles having a combination of active copper compounds. The article may be the top sheet from the previous example. Table 2 provides data on the ion release (in ppm) for various combinations of copper sulfate and cuprous oxide particles at different ratios of compounds and over multiple exposures. As shown in the table, the copper sulfate provides immediate copper ion release and the cuprous oxide particles provide a more durable copper ion release and continued contact killing. Table 2 provides the expected combined ion release rates for the combinations of copper sulfate and cuprous oxide particles from 10 wt. % CuSO₄ and 90% Cu₂O to 100 wt. % CuSO₄ in 10 wt. % increments. The ion release rates of other combinations of copper (or other compounds) may be calculated from the data provided in Table 1 or additional experimental data.

TABLE 2
Copper ion release from articles comprising
combinations of CuSO₄ and Cu₂O

| | Copper ion release (ppm) from article containing fraction | | | | | | |
|---|---|---|---|---|---|---|---|
| Exposure | of CuSO₄ and rest being Cu₂O particles | | | | | | |
| cycle | 0.10 | 0.20 | 0.30 | 0.40 | 0.60 | 0.80 | 1.00 |
| 0 | 13.15 | 22.80 | 32.45 | 42.10 | 61.40 | 80.70 | 100.00 |
| 5 | 2.70 | 2.40 | 2.10 | 1.80 | 1.20 | 0.60 | 0.00 |
| 10 | 2.43 | 2.16 | 1.89 | 1.62 | 1.08 | 0.54 | 0.00 |
| 15 | 2.07 | 1.84 | 1.61 | 1.38 | 0.92 | 0.46 | 0.00 |
| 20 | 1.89 | 1.68 | 1.47 | 1.26 | 0.84 | 0.42 | 0.00 |
| 25 | 1.71 | 1.52 | 1.33 | 1.14 | 0.76 | 0.38 | 0.00 |
| 30 | 1.53 | 1.36 | 1.19 | 1.02 | 0.68 | 0.34 | 0.00 |
| 35 | 1.35 | 1.20 | 1.05 | 0.90 | 0.60 | 0.30 | 0.00 |
| 40 | 1.17 | 1.04 | 0.91 | 0.78 | 0.52 | 0.26 | 0.00 |
| 45 | 1.08 | 0.96 | 0.84 | 0.72 | 0.48 | 0.24 | 0.00 |
| 50 | 0.99 | 0.88 | 0.77 | 0.66 | 0.44 | 0.22 | 0.00 |

The ion release rates may be quantified in a variety of experiments and extrapolation of data. For example, Table 3 provides copper ion release data of various particle sizes of cuprous oxide particles after exposure to various quantities of water from 500 gallons to 20,000 gallons. Such data would allow calculation of the effective service life of an article comprising copper oxide particles in a continuous or intermittent water flow. The effective service life could be estimated as over when the active particles are no longer releasing sufficient ions to maintain the efficacy of the article for a specific application.

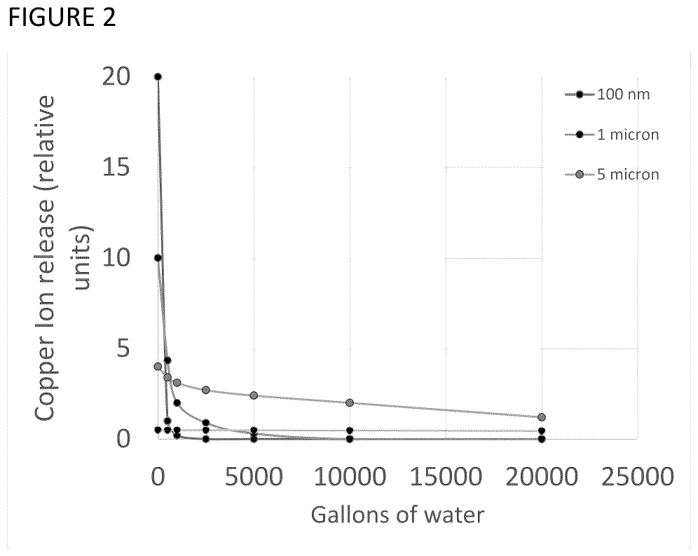

An example includes an irrigation emitter head. Irrigation emitter heads provide irrigation water directly adjacent to the root systems of plants. With the irrigation emitter heads buried in the ground, water may be efficiently delivered to the plants with greatly reduced evaporation and, therefore, greatly increased intake of the delivered water by the plant, and thus reducing the amount of the water need to be delivered. However, the roots of the plants naturally grow toward a source of water and nutrients and, therefore, may clog the outlet of the emitter head by growing into the outlet of the emitter head. Copper particles and copper ions prevent root growth. Emitter heads are exposed to slow flow rates but large amounts of water over their service life and the copper compounds may be selected for long term durable release of copper ions. However, an initial dosing of the soil around the emitter head (such as from copper sulfate or copper iodide) will prevent immediate growth of roots into the area adjacent to the emitter head and a longer-term maintenance of the ion release (such as from copper oxides or copper sulfides) will provide significantly better protection of the water flow than one compound alone. FIG. 2 is a graphical representation of the data in Table 3. Further, the particles sizes of the particles may be provided to further control the ion release to the desired specification and service life.

TABLE 3
Copper Ion release data from Copper Oxide in ppm.

| Gallons of water\Size | Copper ion release (ppm) from copper oxide | | | |
|---|---|---|---|---|
| (micron)] | 0.1μ | 1.0μ | 5.0μ | 20.0μ |
| 0 | 20.0 | 10.0 | 4.0 | 0.5 |
| 500 | 1.0 | 4.3 | 3.4 | 0.5 |
| 1000 | 0.2 | 2.0 | 3.1 | 0.5 |
| 2500 | 0.0 | 0.9 | 2.7 | 0.5 |
| 5000 | 0.0 | 0.3 | 2.4 | 0.5 |
| 10000 | 0.0 | 0.0 | 2.0 | 0.5 |
| 20000 | 0.0 | 0.0 | 1.2 | 0.5 |

FIG. 2 is a graphical representation of the data shown in Table 3.

Another property of the particles that may be embedded in the polymers is the absorption spectrum of the particles. Copper iodide particles absorb laser welding light frequencies, but these same frequencies pass through copper oxide particles. Therefore, an embodiment of article may comprise a first component comprising copper oxide particles laser welded to a second component comprising copper iodide particles.

As used herein, a plurality of particles has a particle size range if at least 90% of the particles have a particle size with the stated particle size range. The ultimate particle size range may be the defined as the range between the smallest particle and the largest particle of the plurality of particles in a powder or in a masterbatch. The distinct particle size ranges may provide the plurality of first particles and the plurality of second particles distinct properties such as, but not limited to, a different copper ion release rate. Thus, as the fiber or article is initially used there would be an initial high rate of ion release as both the first particles and second particles release ions into the application environment, however, the copper ion release rate may diminish as faster ion release rate diminishes over time and the slower ion release rate is maintained as shown in FIGS. 1 and 2. In such embodiments, the application area may initially have a higher dose rate. This may be useful in certain applications such as, but not limited to, root control or sutures. For surgical sutures, the postoperative infection rate is highest, and the initial higher dose rate will prevent infections and the lower ion release rate will maintain the antimicrobial effect and improve wound healing.

The data provided in the tables include ion release rates for specific compounds having discrete particle sizes. In practice, the particles however, that are provided may be a mixture of particles in a particle size range. This mixture of particles may be defined as the plurality of first particles or the plurality of second particles or a first powder and a second powder. The overall ion release rate of the plurality of first particles or first powder may be calculated over the particle size range or estimated by using the average particle size of the plurality of first particles (or powder) or the plurality of second particles (or powder).

For example, the plurality of first particles or plurality of second particles, etc. may be select from the following sets of particles: copper oxide particles having an average particle size of 1.0 micron to 2.0 microns and a particle size distribution in the range of 0.1 micron to 5.0 microns (Example Powder 1); copper oxide particles having an average particle size of 3.0 micron to 4.0 microns and a particle size distribution in the range of 0.1 microns to 20.0 microns (Example Powder 2); copper oxide particles having an average particle size of 0.4 microns to 0.6 microns and a particle size distribution in the range of 0.2 microns to 2.5 microns (Example Powder 3); and copper oxide particles having an average particle size of 1.0 micron to 2.0 microns and a particle size distribution in the range of 0.2 micron to 5.0 microns (Example Powder 4). These sets of particles may be referred to as plurality of particles or powders.

In embodiments of the method of producing the article, the two individual powders may be added directly to the polymer to form the article or added with a masterbatch. In embodiments where the copper compounds are added as a masterbatch, a first masterbatch may comprise a first powder and a second masterbatch may comprise the second powder. Thus, an embodiment of the method may comprise adding at least two distinct masterbatches to the polymer, wherein a first masterbatch comprises a first powder and the second masterbatch comprises a second powder. In another embodiment, a masterbatch comprising two or more distinct powders may be produced. Such masterbatches may be referred to as bimodal or multimodal masterbatches and will be characterized as having particles with multiple distinct peaks in their particle size distribution. A bimodal masterbatch may comprise Example Powder 1 and Example Powder 2 embedded in a polymer with the additional components as described in United States Patent Application Publication No. US 2008/0193496. The masterbatches may further comprise antimicrobial polymers such as, but not limited to, polyhexamethylene biguanide.

Either the first particle, the second particle or both particles may consist essentially of water insoluble copper compounds that release at least one of Cu+ ions and Cu++ ions upon contact with a fluid. The invention has been primarily exemplified with copper particles, however, the particles may be any particles which provide desired properties to the fiber including, but not limited to, cuprous oxide (Cu₂O), cupric oxide (CuO), cuprous iodide (CuI), cuprous thiocyanate (CuSCN), copper sulfide, copper sulfate (CuSO₄), copper chloride (CuCl₂), zeolites, especially copper-zeolites, zirconium phosphate, copper-zirconium phosphate, zinc pyrithione, zinc oxide, titanium oxide, titanium dioxide, titanium oxide, silver nitrate, silver oxide, and silver oxide, silver iodide, silver chloride, silver sulfate, silver sulfide, quaternary ammonium compounds, and combinations thereof. In the description of specific examples, any of the listed particles may be substituted to provide the desired static or dynamic properties.

In one embodiment, the first particles comprise a first property and the second particles comprise a second property that is different than the first property. In an embodiment of a fiber, the average diameter of the first particle may be in the range of 5% and 10% of the average diameter of the polymeric fiber and/or the average diameter of the plurality of second particles may be in the range of 15% and 20% of the average diameter of the polymeric fiber. Other any other particle size ranges that provide the desired properties from initial use to the end of the articles service life.

In a further embodiment, the first particle size range and the second particle size range do not overlap. In still further embodiment, average particle size of the plurality of first particles in the first particle size range is greater than an average particle size of the plurality of second particles in the in the second particle size range. In some embodiments, the average particle size of the plurality of first particles is more than twice the average particle size of the plurality of second particles.

In some embodiments, the first and second particles may have different composition. For example, the first particles and the second particles may comprise, but not limited to, at least one of copper iodide, copper chloride, copper oxide or other particle compositions described herein. In another embodiment, the first particle and the second particle may independently consist essentially of one of copper iodide, copper chloride, and copper oxide. For example, the first particles may consist essentially of copper oxide particles and the second particles consist essentially of copper iodide particles. One or more of the plurality of particles may comprise a blend of particles such as a blend of copper oxide and copper iodide particles, for example, the plurality of particles comprises copper iodide particles in the concentration range of 5 wt % to 90 wt. % and copper oxide particles in the concentration range of 95 wt. % to 10 wt. %. The plurality of particles may be added to the polymeric material as either a dry powder or as a component in one or more masterbatch. The average particle diameter, the fiber diameter, and the particle size ranges are measured by known methods.

Embodiments of the invention may comprise solid surfaces and molded products. The solid surfaces may comprise two or more different copper compounds as described above. The solid surfaces may be similar to the solid surfaces and the methods for producing solid surface as described in United States Patent Application Publication US 2015/0320035 which is hereby incorporated by reference in its entirety.

Embodiments of also include a method of producing an antimicrobial, antiviral and antifungal material, article, fiber, nonwoven, film, solid surface, or molded article. The method of producing an antimicrobial, antiviral and antifungal material may comprise mixing a polymeric material, a first polymeric masterbatch comprising first particles comprising water insoluble copper compounds that release at least one of Cu+ ions and Cu++ ions upon contact with a fluid in a first particle size range, and a second polymeric masterbatch comprising second particles comprising water insoluble copper compounds that release at least one of Cu+ ions and Cu++ ions upon contact with a fluid in a second particle size range. The first particle size range may be different than the second particle size range.

The method may comprise adding particles in the first masterbatch have a first rate of copper ion release and the particles of the second masterbatch have a second rate of copper ion release and the first rate of copper ion release is different than the second rate of copper ion release. The first masterbatch have a first rate of copper ion release and the particles of the second masterbatch have a second rate of copper ion release. In some embodiments, the first rate of copper ion release is greater than the second rate of copper ion release.

### Example 1

An incontinence device typically comprises a top sheet, an absorbent core, and a water impermeable bottom sheet. The top sheet and/or absorbent core may comprise active particles. The active particles may be any particles as described herein. For example, water insoluble copper compounds that release at least one of Cu+ ions and Cu++ ions upon contact with a fluid may be added to at least one of the top sheet, the absorbent core and the bottom sheet or another component of the diaper to inhibit the catalytic hydrolysis of urea in urine by urease. The water insoluble copper compounds thereby reduce the rate of degradation of the urea to ammonia and carbon dioxide. The antimicrobial copper particles may also reduce the risks of infection of the wearer. By significantly reducing the formation of ammonia, the pH of the environment within the diaper can be maintained slightly acidic and more beneficial to skin health.

In one embodiment, the incontinence device may comprise an absorbent layer, wherein the absorbent core comprising a superabsorbent polymer or pulp. The superabsorbent polymer or pulp comprises a plurality of first particles and a plurality of second particles. The plurality of the first particles is within a first particle size range and the plurality of second particles within a second particle size range to provide specific properties to the absorbent core. In one embodiment, the first particle size range is different than the second particle size range.

In a further embodiment, the first particles and second particles of the absorbent core consist essentially of water insoluble copper compounds that release at least one of Cu+ ions and Cu++ ions upon contact with a fluid.

In a still further embodiment, the incontinence device may further or independently comprise a nonwoven top sheet, wherein the top sheet comprises a polymeric material and a plurality of third particles, wherein the third particles comprise water insoluble copper compounds that release at least one of Cu+ ions and Cu++ ions upon contact with a fluid embedded in the polymeric material and the plurality of third particles having a third average particle diameter, wherein the average diameter of the particle is in the range of 5% and 10% of the average diameter of fibers of the polymeric material. The third average particle diameter may be greater than a first average particle size range of the plurality of particle size to provide higher contact killing properties for microbes on the skin of the wearer.

### Example 2

Embodiments of an irrigation emitter head may comprise an outlet portion and an inner water flow channel. In use, the irrigation heads are subject to be clogged by the roots of the plants being watered by the irrigation system. It has been found that water insoluble copper compounds that release at least one of Cu+ ions and Cu++ ions upon contact with a fluid are capable of controlling root growth and significantly reducing the ability of the roots to clog the irrigation system. It is hypothesized that the copper compounds may prevent clogging by two actions. First, the copper ions are released as the water flows and carries the ions into the area adjacent to the irrigation head reducing root growth in this area. Further, copper compounds that protrude from the irrigation head may prevent clogging of the irrigation emitter head by direct contact with the root. Different sized particles may provide these different properties.

Therefore, an embodiment of an irrigation emitter head may comprise a water outlet portion; and an inner water flow channel, wherein the water outlet portion comprises a first polymeric material and a plurality of first particles comprising water insoluble copper compounds that release at least one of Cu+ ions and Cu++ ions upon contact with a fluid having a first average particle size and the inner water flow channel comprises a second polymeric material and a plurality of second particles comprising water insoluble copper compounds that release at least one of Cu+ ions and Cu++ ions upon contact with a fluid having a second average particle size. The first particle has lower copper ion release rate than the second particle. In one embodiment, the first average particle size may be larger than the second average particle size.

In a further embodiment, the first particles and second particles of the emitter head and the water channel consist essentially of water insoluble copper compounds that release at least one of Cu+ ions and Cu++ ions upon contact with a fluid. The particles comprise one or more of copper oxide and copper iodide.

### Example 3

Surgical sutures may comprise a plurality of first particles and a plurality of second particles. In surgery requiring sutures, the postoperative infection rate is highest in the period immediately following surgery, but the risk of infection may continue beyond this immediate post-operative period. For sutures comprising the plurality of first particles and the plurality of second particles, an initial higher dose rate will prevent infections and the lower ion release rate will maintain the antimicrobial effect and improve wound healing.

In one embodiment, a suture may comprise a polymeric fiber or yarn, wherein the fiber or yarn comprises a plurality of first particles and a second particles, wherein the plurality of the first particles are within a first particle size range and the plurality of second particles within a second particle size range, wherein the first particles and second particles comprise water insoluble copper compounds that release at least one of Cu+ ions and Cu++ ions upon contact with a fluid incorporated the polymeric fiber or yarn, wherein the first particle size range is different than the second particle size range.

The listed ion release rates are examples and are given to show generally the relative ion release rates of the particles of different composition and particle sizes.

1. An antimicrobial, antiviral, and antifungal material, comprising:
a polymer;
a plurality of first particles within a first particle size range, wherein the particle comprises copper compounds that release at least one of Cu+ ions and Cu++ ions upon contact with a fluid embedded in the fiber; and
a plurality of second particles within a second particle size range, wherein the particle comprises copper compounds that re lease at least one of Cu+ ions and Cu++ ions upon contact with a fluid embedded in the fiber, wherein the first particle size range is different than the second particle size range.

2. The antimicrobial, antiviral, and antifungal material of claim 1, wherein the first particle size range and the second particle size range do not overlap.

3. The antimicrobial, antiviral, and antifungal material of claim 2, wherein an average particle size of the particles in the first particle size range is greater than an average particle size of the particles in the in the second particle size range.

4. The antimicrobial, antiviral, and antifungal material of claim 1, wherein the first particles consist essentially of copper oxide particles and the second particles consist essentially of copper iodide particles.

5. An incontinence device, comprising:
an absorbent layer, wherein the absorbent layer comprises a superabsorbent polymer, wherein the superabsorbent polymer comprises a plurality of first particles and a second particles, wherein the plurality of the first particles are within a first particle size range and the plurality of second particles within a second particle size range, wherein the first particles and second particles comprise water insoluble copper compounds that release at least one of Cu+ ions and Cu++ ions upon contact with a fluid incorporated into the superabsorbent polymer, wherein the first particle size range is different than the second particle size range.

6. The incontinence device of claim 5, wherein the first particles and second particles consist essentially of water insoluble copper compounds that release at least one of Cu+ ions and Cu++ ions upon contact with a fluid.

7. The incontinence device of claim 5, further comprising:
a nonwoven top sheet, wherein the top sheet comprises a polymeric material and a plurality of third particles, wherein the third particles comprise water insoluble copper compounds that release at least one of Cu+ ions and Cu++ ions upon contact with a fluid embedded in the polymeric material and the plurality of third particles having a third average particle diameter, wherein the average diameter of the particle is in the range of 5% and 10% of the average diameter of fibers of the polymeric material.

8. The incontinence device of claim 7, wherein the third average particle diameter is greater than a first average particle size range of the plurality of particle size.

9. A method of producing an antimicrobial, antiviral and antifungal material, comprising:
mixing a polymeric material, a first polymeric masterbatch comprising first particles comprising water insoluble copper compounds that release at least one of Cu+ ions and Cu++ ions upon contact with a fluid in a first particle size range, and a second polymeric masterbatch comprising second particles comprising water insoluble copper compounds that release at least one of Cu+ ions and Cu++ ions upon contact with a fluid in a second particle size range, wherein the first particle size range is different than the second particle size range.

10. The method of claim 9, wherein the particles in the first masterbatch have a first rate of copper ion release and the particles of the second masterbatch have a second rate of copper ion release and the first rate of copper ion release is different than the second rate of copper ion release.

11. The method of claim 9, wherein the particles in the first masterbatch have a first rate of copper ion release and the particles of the second masterbatch have a second rate of copper ion release and the first rate of copper ion release is greater than the second rate of copper ion release.

12. The method of claim 9, further comprising:
melting the polymeric material; and
extruding the polymeric material into fibers, wherein the fibers have a fiber diameter and the first particles in the first masterbatch have an average particle size, the average particle size is in the range of 5% and 10% of the average diameter of the polymeric fiber.

13. The method of claim 12, wherein the second particles in the second masterbatch have a second average particle size, the second average particle size is in the range of 5% and 10% of the average diameter of the polymeric fiber.

14. The method of claim 13, wherein the first average particle size is greater than the second average particle size.

15. The method of claim 14, wherein the first particles have a copper ion release rate that is lower than the copper ion release rate of the second particles.

16. The method of claim 12, wherein the polymeric material comprises at least one of a thermoplastic polymer, polyester, a polyolefin, a polypropylene, or polyamide.

17. The method of claim 9, further comprising:
melting the polymeric material; and
molding the polymeric material into a molded product.

18. The method of claim 17, wherein the polymeric material comprises at least one of a thermoset polymer, thermoplastic polymer, polyester, a polyolefin, a polypropylene, Acrylonitrile butadiene styrene, or polyamide.

19. An antimicrobial, antiviral, and antifungal solid surface, comprising:
a polymeric panel;
a plurality of first copper compounds that release at least one of Cu+ ions and Cu++ ions upon contact with a fluid embedded in the fiber; and
a plurality of second copper compounds that re lease at least one of Cu+ ions and Cu++ ions upon contact with a fluid embedded in the fiber, wherein the first copper compounds are different from the second copper compounds in at least one property selected from the group comprising copper ion release rates, chemical composition, contact killing properties, optical qualities, particles size distributions, average particle sizes, particle size distribution, and combinations thereof.

20. The antimicrobial, antiviral, and antifungal solid surface of claim 19, wherein the panel is a countertop.

21. The antimicrobial, antiviral, and antifungal solid surface of claim 19, wherein the first copper compound is a copper oxide and the second copper compound is a copper iodide.

22. The antimicrobial, antiviral, and antifungal solid surface of claim 19, wherein the first copper compound has a first particle size distribution and the second copper compound has a second particle size distribution and the first particle size distribution is different than the second particle size distribution resulting in a bimodal particle size distribution in the solid surface.
